(19) United States
(12) Patent Application Publication
(10) Pub. No.: US 2016/0283473 A1
(43) Pub. Date: Sep. 29, 2016

(54) Method and Computer Program Product for Implementing an Identity Control System

(71) Applicants: Daniel Heinze, San Diego, CA (US); John Holbrook, Easthampton, MA (US); Paul McOwen, Northfield, MA (US)

(72) Inventors: Daniel Heinze, San Diego, CA (US); John Holbrook, Easthampton, MA (US); Paul McOwen, Northfield, MA (US)

(73) Assignees: Gnoetics, Inc., San Diego, CA (US); Zato Health, Inc., Springfield, MA (US)

(21) Appl. No.: 15/076,299

(22) Filed: Mar. 21, 2016

Related U.S. Application Data
(60) Provisional application No. 62/138,880, filed on Mar. 26, 2015.

(51) Int. Cl. G06F 17/30

(52) U.S. Cl. CPC G06F 17/30011; G06F 17/30477; G06F 17/30554; G06F 17/3053

(57) ABSTRACT

Method and computer program products for implementing an identity control system are disclosed. Documents are abstracted by mapping non-identifying words in the documents to non-identifying concepts that are designated by codes, which codes are linked to non-identifying descriptions and may optionally non-identifying values. Similarly, identifying words in the documents are abstracted by mapping identifying and/or potentially identifying words in the documents to identifying concepts that are designated by codes, which codes are themselves non-identifying and have non-identifying descriptions and may optionally have values, which values may be identifying or may be obfuscations of the identifying information. Non-identifying codes and optional values, the words that are mapped to those codes and stop-words are indexed as non-identifying index data. Identifying codes and optional values, and the words that are mapped to those codes are indexed as identifying index data. An access unit controls the authentication, authorization and access to the query, analysis and retrieval methods that operate on the non-identifying and identifying indexes in such a manner as to provide only the type, level, format and duration of identifying information to which the end-user is authorized. Storage and access control of documents along with their codes and indexes may be local or federated, and is under the control of the identifying information owners and/or their authorized agents who may grant access to end-users within a local or federated set of identity control systems.

### CLAIM OF PRIORITY

This application claims priority under 35 USC §119(e) to U.S. Patent Application Ser. No. 62/138,880, filed on Mar. 26, 2015, the entire contents of which are hereby incorporated by reference.

### CROSS-REFERENCE TO RELATED APPLICATIONS

Not Applicable.

### STATEMENT REGARDING FEDERALLY SPONSORED RESEARCH OR DEVELOPMENT

Not Applicable

### REFERENCE TO SEQUENCE LISTING, A TABLE, OR A COMPUTER LISTING COMPACT DISK APPENDIX

Not Applicable

### TECHNICAL FIELD

The following disclosure relates to methods and computerized tools for controlling the access to and dissemination of identifying information (“identity control”) on source data by means of abstraction, manipulation, indexing/search/retrieval, and access control techniques. Identifying information is information that specifically identifies a particular individual or entity whose association with the larger body of information contained in the data may be protected from disclosure either by statute or by the desires of the information owners.

### BACKGROUND OF THE INVENTION

Identity control on disseminated data is typically attempted using techniques for de-identification of source data, and is typically performed by first locating identifying information within the source data and then modifying the data by redacting, removing, obfuscating or abstracting such identifying information so that disseminated data no longer discloses the identity of some individuals or entities. When source data exists in a structured format such as a database with narrow data type definitions for each field, it may be straight-forward to remove the identifying information. If, however, the source data is not fully structured or is unstructured (for example free-text documents, images, sound recordings), locating the identifying information with perfect precision and recall is very difficult. In fields where identifying information is protected by statute, for example, personally identifiable information (PII) or protected health information (PHI), the penalties even for unintentional release of identifying information can be substantial. As a result, large bodies of data that would be of significant use for research remain unavailable to the wider community because automated de-identification methods have not proven sufficiently accurate and manual methods are too labor intensive and are subject to inaccuracies due to human error.

A second method for de-identification consists of locating non-identifying information in the document and then removing all other data. For example, with regard to PHI, this non-identifying information could include signs, symptoms, findings, procedures, medications and outcomes. Automated methods that embody this approach have not, however, been embraced because the precision and recall of automated methods for locating only non-identifying information is not better than the precision and recall of automated methods for locating identifying information. As a result, identifying information may still evade the filter.

A third method for de-identification enhances the second method described above by means of additional filtering using some method for abstracting all of the non-identifying information so that only information that has been abstracted in a manner that can contain no identifying information passes the filter and none of the source data passes the filter. For example, PHI would be coded, that is reduced to some set of codes based on coded, standardized terminologies for medical signs, symptoms, findings, diagnoses, procedures, medications and outcomes (e.g. International Classification of Diseases (ICD), Current Procedural Terminology (CPT), Systematic Nomenclature of Medicine (SNOMED), et al.). This method achieves the goal of de-identification, but is generally rejected for research purposes because the accuracy of the information in terms of precision and recall, is compromised first by the location process and then by the abstraction process and there is no method by which to evaluate the accuracy of any or each item of coded information.

It is desirable, therefore, to have a method that achieves the goals of locating all non-identifying information of interest, abstracting the non-identifying information of interest by means of coding, and further achieves the goals of rating the accuracy of the coded information, and providing a secure and compliant path and access method to the original source data that may be accessed in compliance with applicable statutes and policies or with the permission of the data owners.

### SUMMARY OF THE INVENTION

Techniques are disclosed for identity control. The disclosed techniques: 1) perform data abstraction in such a manner as to create a representation that contains no individual or entity identifying information; 2) manipulate identifying information so as to obfuscate identities or abstract identities to a group rather than individual or entity level; 3) index and store data at local computing sites (edge-computing) that perform federated search and retrieval operations; 4) provide access control that physically and logically remains under the authentication and authorization powers of the identifying information owners and/or their authorized agents (owners). In this manner, data that contains identifying information can be shared with a broad end-user community using techniques that allow the owners to control access to the identifying information.

Data abstraction of both identifying and non-identifying information is performed by means of data coding (“coding”) that includes both a rating of the accuracy and reliability of each code and contextual information relating each code to the other codes. The terms “code” or “codes” are used to refer to both the typically alpha-numeric designation of a concept in some terminology or ontology as well as any description of the meaning of that code and any relations that any individual code may have to other codes.

Identifying information manipulation is performed by removal, redaction, obfuscation or abstraction of information that is either specifically determined to be identifying information or that has not been determined to be non-identifying information.

Data indexing is performed by edge-computing that maintains the source data, the abstract data, the manipulated data and the indexes at sites that are under the access control of the data owners. Data search is performed by the edge-computing nodes the results of which are federated so as to produce retrieval and analysis results that are normalized across the entire federation.

Access control is specific to each edge-computing node that provides authentication, authorization and role controlled access to role specific levels of administration, search and retrieval of the edge-computing node data, abstractions, manipulations and indexes.

Techniques are described with reference to data and information in the form of documents, fields and words. It is, however, within the scope of the invention that “document” and/or “documents” refer to any form or aggregation of data, including but not limited to files in file systems, free-text documents, database records, data collections, assemblies, images and sound recordings, that may optionally contain identifying information (information that would specifically identify some individual including but not limited to individuals, patients, customers, residents, employees and family members, or discrete entity including but not limited to companies, organizations, governing bodies, residences, employers, nations, and hospitals, and which data is compositionally formed from separable and optionally hierarchically or contextually arranged components (here referred to as “words”) including but not limited to words, multi-words, subsets, areas, components, subassemblies, tokens, fields, labels, database elements and sets.

In one aspect, documents in electronic form are processed by an NLP engine whereby the concepts contained in a source document are abstracted in the form of codes including but not limited to codes from standardized terminologies or ontologies including but not limited to the International Classification of Diseases (ICD), Current Procedural Terminology (CPT), and Systematic Nomenclature of Medicine (SNOMED). Additionally, each code may have zero or more qualifiers, each of which is itself a code that identifies the qualifier type and zero or more values that characterize the qualifier. Qualifiers include but are not limited to: 1) the certainty of the abstracted code concept as expressed by the source document author (author's certainty); 2) the estimated correctness of the code that was abstracted my mapping source data to a code (abstraction certainty); 3) the relation of the abstracted code to other abstracted codes in the same or other documents; 4) a characteristic of the abstracted code concept with zero or more values including but not limited to various measurement values and the identification of the measurement scale. Each code is designated as representing either a non-identifying concept or an identifying concept, for example name, social security number and date of birth are identifying concepts, whereas pneumonia, heart valve replacement, and shortness of breath are non-identifying concepts. Additionally, words that are commonly referred to as “stop words”, for example “the”, “a”, “from”, “to”, etc. are also typically designated as non-identifying. It is within the scope of the invention that in the manner that word refers to any component type that stop-word refer to any component type from which the members of that type cannot in normal usage be composed so as to form identifying information. The process of abstraction is that by which codes are mapped onto the source documents specifically linking the abstracted codes to the specific words in the source documents that support each code, and in which abstraction, all words that support non-identifying concepts are, themselves individually, non-identifying. If the source document exists in some structured forms such as a database, the same process would apply. It is within the scope of the invention that abstraction be performed by methods including but not limited to manual abstraction by human abstractor, or automatically by an NLP engine, a structure analyzer, a fixed pattern matcher, a finite state pattern matcher, a data dictionary, etc.

A source document that is abstracted in this manner is then indexed on the non-identifying words, stop-words and abstracted concepts, queried, searched, retrieved and/or presented in a form that contain only non-identifying information either in the form of abstracted codes with qualifiers and/or source documents that are redacted so as to show only non-identifying words and stop-words and optionally codes and/or their non-identifying descriptions. In some implementations, the qualifiers and/or associations between abstracted codes may be expressed graphically or visually using techniques including but not limited to varied colors, graphing, and tabular format.

A full index of the original source documents is also generated using both identifying and non-identifying information composed of words and codes. The full index is securely stored at a location or locations that are controlled by the owner of the identifying information or the owners designated agent(s). In some implementations, consumers of the non-identifying information may request access to the full original source documents. If the request is approved, the owner or agent(s) may grant access. In some implementations, access may be limited in extent, form and duration of access.

### BRIEF DESCRIPTION OF THE DRAWINGS

FIG. 1A is a functional block diagram of an identity control system.

FIG. 1B is a functional block diagram of an identity control system executing on a computer system.

FIG. 1C is a detailed view of an information indexing application.

FIG. 1D is a detailed view of an access unit.

FIG. 2 is a flow chart of an information abstracting algorithm.

Like reference symbols in the various drawings indicate like elements.

### DETAILED DESCRIPTION OF THE INVENTION

Novel techniques are disclosed for identity control by: 1) performing data abstraction in such a manner as to create a representation that contains no individual or entity identifying information (data abstraction); 2) manipulating identifying information so as to obfuscate identities or abstract identities to a group rather than individual or entity level (identity manipulation); 3) indexing and storing data at local computing sites (edge-computing) that perform federated search and retrieval operations (data indexing); 4) providing access control that physically and logically remains under the authentication and authorization powers of the identifying information owners (access control).

Data abstraction is performed by creating separate abstractions of both non-identifying information and identifying information in source data by means of coding that includes a rating of the accuracy and reliability of each code, optional qualifiers and values for each code, and contextual information relating each code to the other codes. Identity manipulation is performed by replacing both identifying and non-identifying information with data abstraction and/or with source data that is composed of only non-identifying words. Indexing data is performed by edge-computing techniques for storing, indexing, searching, and retrieving the separate indexes for non-identifying information, identifying information and the original source data. Access control is performed by methods for user authentication and authorization according to roles that control who may access what data, when, where, how, and for how long.

While the following describes techniques in context of medical coding and abstracting and are particularly exemplified with respect to coding medical documents, some or all of the disclosed techniques can be implemented to apply to any text, language, image, numerical, unstructured or structured data processing system in any industry or domain in which it is desirable to perform identity control tasks against some documents.

Various implementations of identity control are possible, including both manual and automated techniques. The implementation of techniques based on NLP, surface form ontologies and edge-computing used in the method for identity control here illustrated are based in and include, but are not limited to, the use of NLP software systems developed by Gnoetics, Inc. and in commercial use since 2009 and edge-computing indexing and retrieval methods developed by Zato, Inc. and in commercial use since 2013, the L-space semantics as published in Daniel T. Heinze, “Computational Cognitive Linguistics”, doctoral dissertation, Department of Industrial and Management Systems Engineering, The Pennsylvania State University, 1994, Indexed Natural Language Processing—U.S. patent application Ser. No. 14/230,652, and Detecting and Identifying Erroneous Medical Abstracting and Coding and Clinical Documentation Omissions—U.S. patent application Ser. No. 14/230,580. Extending the techniques embodied or described in these sources, novel techniques for identity control are disclosed.

In one aspect, data abstraction is performed on documents in electronic form that are abstracted to both non-identifying and identifying codes that are mapped, in the form of annotations, onto the document words that may themselves also be characterized by phrases, clauses, sentences, paragraphs, sections and document source/type. The abstracted code annotations that are mapped onto the source documents are stored for indexing along with the documents. Any competent method of abstracting, including but not limited to

Natural Language Processing (NLP), pattern matching, finite state analysis, data type mapping, structure analysis, or manual markup by human abstractors may be used to perform abstracting. To the degree that the abstracting system is capable, each mapping of an abstract code onto one or more characterized words in a source document is rated according to the certainty that the mapping of the abstract code onto the one or more words in the source document is semantically correct (abstraction certainty). The process of determining abstraction certainty may be either automatic or manual or some combination of automated and manual techniques.

Identity manipulation is performed in that the source documents may be redacted by filtering out all but the words that are mapped to non-identifying codes or non-identifying stop words in the source documents. Words that are not mapped to non-identifying codes or non-identifying stop words may be replaced in the redaction by place-holder words so that index and search methods that depend on proximity will not be adversely affected. In some implementations, certain identifying codes that are mapped onto the source documents may be used to redact the source documents by replacing the original words in the source document with approved underspecified terms rather than place-holder words—for example, John Doe may be underspecified as “personal name 1” or “Springfield, Mass.” may be underspecified as “NE US”.

Data indexing is performed on the redacted source documents and code annotations. The redacted source documents and code annotations are indexed for search and retrieval using any competent means of indexing, including but not limited to inverted-indexing, hashing, tree or graph structures, fuzzy matching, Bayesian matching, vector matching, inverted cosine, etc., any of which may be employed without departing from the spirit and scope of the claims. For indexing purposes, words may be single word or a multi-word. and are indexed to the begin/end byte offsets or the structured field or record within each document in which they occur. Phrases, according to their type (e.g. prepositional phrase, noun phrase, verb phrase, etc.), clauses, according to their type (e.g. dependent, independent, etc.), sentences (and sentence fragments), according to their type (e.g. declaration, question, etc.), paragraphs, and sections, according to their type (e.g. subjective, objective, assessment, plan, etc.) are indexed to the begin/end byte offsets within each document in which they occur. Document source/type (e.g. lab reports, office visits, discharge summaries, intelligence reports, etc.) are indexed to the documents of that source/type. Code annotations are indexed to the byte offsets of the words they are mapped on to.

In parallel with the non-identifying indexing process, the full original source documents with identifying information and identifying codes are also indexed.

The indexes and search capabilities for source documents that contain only identifying information are created and maintained under the physical and administrative control of the identifying information owner(s) and/or authorized agent(s). In some implementations, this physical and administrative control of identifying information may be implemented using edge-computing techniques.

A query is a construct of words, codes or concepts that can be mapped onto documents via the index. The constructors for a query are set operators that can be satisfied against the index. Traditional query operators include but are not limited to Boolean, Fuzzy Set, term order and term proximity operators. To these we here add the novel query operators (as described in U.S. patent application Ser. No. 14/230,652) of phraseConstraint, clauseConstraint, sentenceConstraint, paragraphConstraint, sectionConstraint and source/typeConstraint, each relating to the indexing of location (begin/end byte offset and document) and, as applicable, being indexed to the grammatical type (e.g. syntactic category, etc.) of the occurrences in the documents.

Access control is provided in that owners or agents having control of identifying information may upon petition grant search and retrieval access to all or some criteria specified subset of the source documents and indexes under their control based on one or more criteria. In some implementations, accessed data may be delivered in such a manner that its location is traceable, it can be accessed only using authorized computers, it can be accessed only by specific authorized users, and/or it may become inaccessible after a certain period of time even after it is delivered to an end-user using techniques including but not limited to those employed in the Zato, Inc. products and other commercial document source control systems and software.

Implementation can optionally include one or more of the following features: identifier collection whereby entity resolution is performed to collect and collate identifying information from multiple and discrete documents under some universal unique identifier; identifier verification whereby the individual and/or entity references in one or more documents in a collected and collated set are verified as to the actual individual and/or entity being referenced.

Identity Control System Design

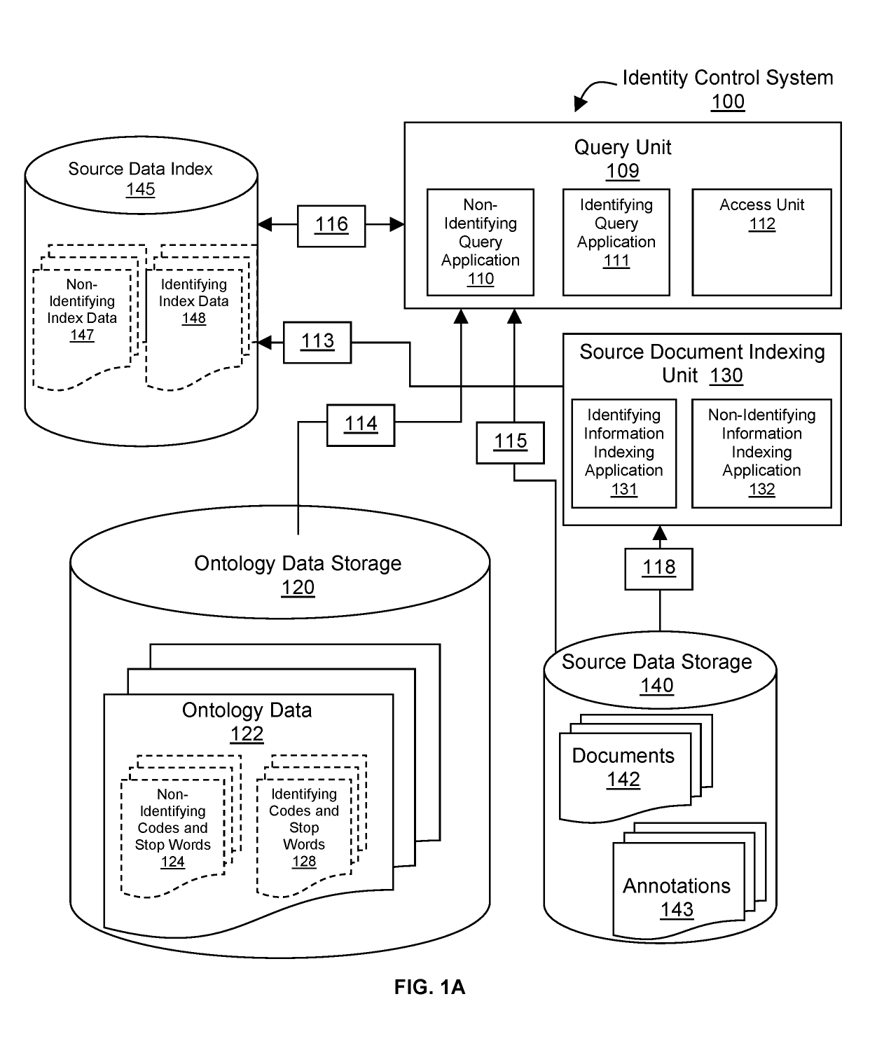

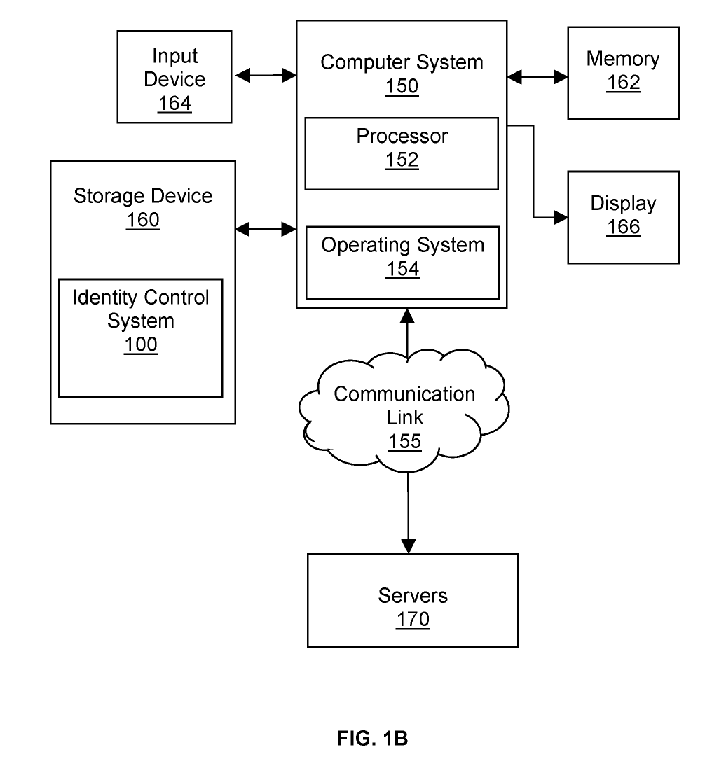

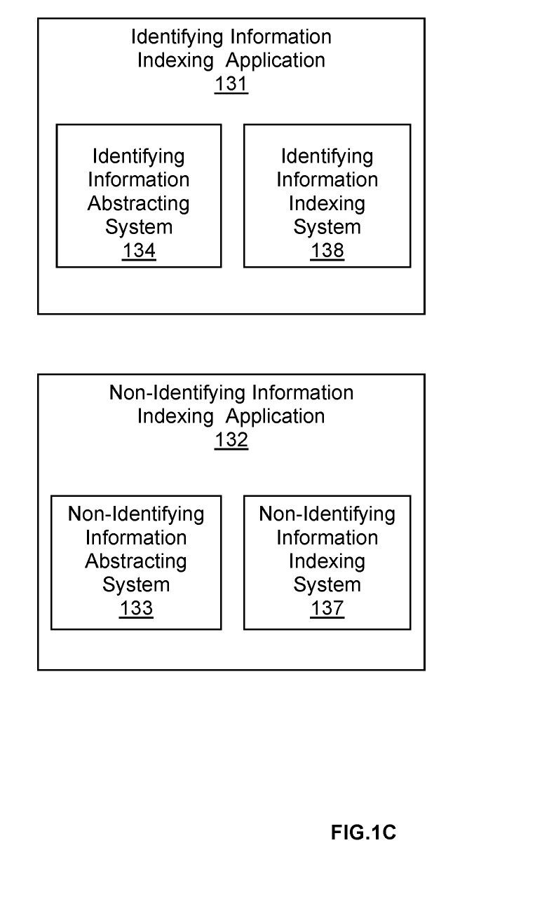

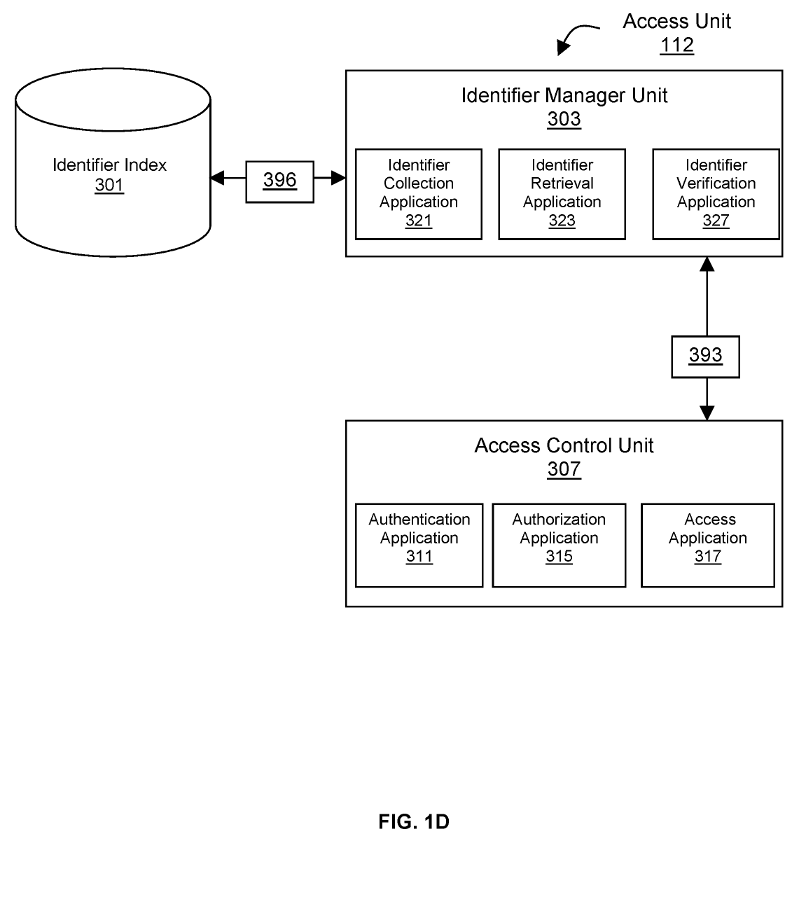

FIG. 1A is a functional diagram of identity control system 100. Identity control system 100 includes source document indexing unit 130 and query unit 109. Source document indexing unit 130 includes identifying information indexing application 131 and non-identifying information indexing application 132. Query unit 109 includes non-identifying query application 110, identifying query application 111, and access unit 112. Identifying information indexing application 131 and non-identifying information indexing application 132 are communicatively coupled to source data storage 140 through communications link 118 and are communicatively coupled to source data index 145 through communications link 113. Non-identifying query application 110, identifying query application 111, and access unit 112 are communicatively coupled to source data storage 140 through communications link 115, are communicatively coupled to ontology data storage 120 through communications link 114, and are communicatively coupled to source data index 145 through communications link 116. Source data index 145 may contain non-identifying index data 147 and/or identifying index data 148. Source data storage 145 may contain documents 142. Documents 142 may be populated using any competent means of selecting, specifying and/or transmitting data. Ontology data storage 120 may contain ontology data 122. Ontology data 122 may contain non-identifying codes and stop words 124 and identifying codes and stop words 128.

FIG. 1B is a block diagram of identity control system 100 implemented as software or a set of machine executable instructions executing on a computer system 150 such as a local server in communication with other internal and/or external computers or servers 170 through communication link 155, such as a local network or the internet. Communication link 155 can include a wired and/or a wireless network communication protocol. A wired network communication protocol can include local wide area network (WAN), broadband network connection such as Cable Modem, Digital Subscriber Line (DSL), Virtual Private Network (VPN), and other suitable wired connections. A wireless network communication protocol can include WiFi, WIMAX, BlueTooth and other suitable wireless connections.

Computer system 150 includes a central processing unit (CPU) 152 executing a suitable operating system (OS) 154 (e.g., Windows® OS, Apple® OS, UNIX, LINUX, etc.), storage device 160 and memory device 162. The computer system can optionally include other peripheral devices, such as input device 164 and display device 166. Storage device 160 can include nonvolatile storage units such as a read only memory (ROM), a CD-ROM, a programmable ROM (PROM), erasable program ROM (EPROM) and a hard drive. Memory device 162 can include volatile memory units such as random access memory (RAM), ‘FLASH’ solid state memory, dynamic random access memory (DRAM), synchronous DRAM (SDRAM) and double data rate-synchronous DRAM (DDRAM). Input device 164 can include a keyboard, a mouse, a touch pad and other suitable user interface devices. Display device 166 can include a Cathode-Ray Tube (CRT) monitor, a liquid-crystal display (LCD) monitor, or other suitable display devices. Other suitable computer components such as input/output devices can be included in or attached to computer system 150.

In some implementations, identity control system 100 is implemented as a web application (not shown) maintained on a network server (not shown) such as a web server. Identity control system 100 can be implemented as other suitable web/network-based applications using any suitable web/network-based computer programming languages. For example Java, C/C++, an Active Server Page (ASP), and a JAVA Applet can be implemented. When implemented as a web application, multiple end users are able to simultaneously access and interface with identity control system 100 without having to maintain individual copies on each end user computer. In some implementations, identity control system 100 is implemented as a local application executing in a local end user computer or as client-server modules, either of which may be implemented in any suitable programming language, environment or as a hardware device with the application's logic embedded in the logic circuit design or stored in memory such as PROM, EPROM, Flash, etc.

In some implementations, identity control system 100 is implemented as a distributed system across multiple computer system 150 (not shown) each of which may contain zero or more source document indexing unit 130, query unit 109, source data storage 140 ontology data storage 120, and source data index 145, in which implementation communications links 113, 114 115, 116 and 118 will, as needed, be web application communications links

Identifying Information Indexing Application

Identifying information indexing application 131 may be any competent indexing application or set of applications that may include but are not limited to term indexing, multi-word indexing, stop wording, stemming, lemmatization, and case normalization.

Non-Identifying Information Indexing Application

FIG. 1C is a detailed view of identifying information indexing application 131 that includes non-identifying information abstracting system 133 and non-identifying information indexing system 137, and non-identifying information indexing application 132 that includes non-identifying information abstracting system 133 and non-identifying information indexing system 137. Identifying information abstracting system 134 and non-identifying information abstracting system 133 can be implemented using either or a combination of NLP and manual abstracting using computer markup tools, any of which can be implemented in Java, C/C++ or any complete programming language and may be run automatically or under manual control. Identifying information indexing system 138 and non-identifying information indexing system 137 can be implemented in Java, C/C++ or any complete programming language and may use any competent indexing application or set of applications that may include but are not limited to term indexing, multi-word indexing, stop wording, stemming, lemmatization, and case normalization.

Information Abstracting Algorithm

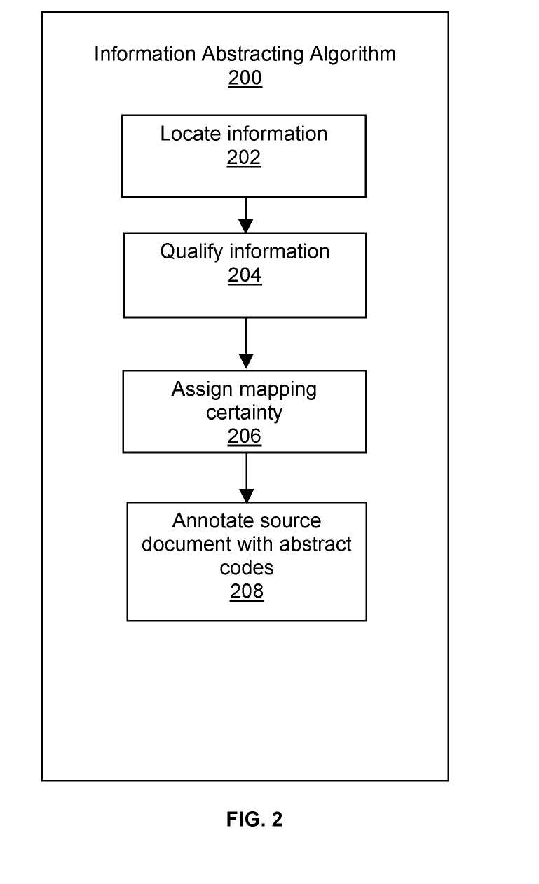

FIG. 2 is a flow chart of information abstracting algorithm 200 for implementing identifying information abstracting system 134 using identifying codes and stop words 128, and for implementing non-identifying information abstracting system 133 using non-identifying codes and stop words 124. Given each source input document from documents 142, which includes structured and/or unstructured words, numbers, punctuations and white or blank spaces to be parsed, information abstracting algorithm 200 begins with locate information at 202 that produces located information comprised of sets of one or more words that are mapped to by one or more abstract codes. The locate information 202 process can be performed automatically by any competent means such as NLP or structured data analysis depending on the input source document nature or may be performed manually by a human abstractor. The locate information 202 process includes locating words that respectively map to identifying words and stop words 128 or non-identifying codes and stop words 124 in ontology data 122 as well as the byte offsets of the beginning and ending of document sections, headings, white space, terms and punctuation so that any mappings to ontology data 122, is mapped back to the original location in documents 142.

The located information is processed at qualify information 204 specifying links between abstract codes such that one or more abstract codes and optionally the values of these abstract codes represent some qualification of one code by the other. The output of qualify information 204 is located and optionally qualified information. Qualification of one code by another code and optionally some value of that code include but are not limited to, for example, severity whereby a code representing a disease or another threat may be qualified by a code for severity with value mild or moderate or severe, etc. Other qualities may include but are not limited to color, size, shape, laterality, quantity, and so on. Qualify information 204 may be an automated process or a manual process. In some implementations, qualify information 204 will be an extension of some automated process such as NLP. In some implementations, qualify information 204 will be performed manually or by some combination of automated and manual processes.

At assign abstraction certainty 206, located and optionally qualified information is assigned a certainty measure reflecting how certain the locate information 202 and qualify information 204 processes are that each code location and qualification are correct. Abstraction certainty may be expressed as a single value for certainty or by multiple values such as precision and recall values, or by a composite value such as F-score or Kappa statistic. Assign abstraction certainty 206 may be an automated process or a manual process. In some implementations, assign abstraction certainty 206 will be an extension of some automated process such as NLP or statistical concept recognition. In some implementations, assign abstraction certainty 206 will be performed manually or by some combination of automated and manual processes.

At annotate source document with abstract codes 208, the located information, qualified information and abstraction certainty are stored in annotations 143. Annotations 143 may be made and recorded using any competent system for annotation, including but not limited to embedded markup, stand-off markup, byte-offset markup, and database relations. Annotate source document with abstract codes 208 may be an automated process or a manual process. In some implementations, annotate source document with abstract codes 208 will be an extension of some automated process such as NLP. In some implementations, annotate source document with abstract codes 208 will be performed manually or by some combination of automated and manual processes.

Information Indexing Algorithm

Annotations 143 produced by identifying information abstracting system 134 or non-identifying information abstracting system 133 are converted to indexes by identifying information indexing system 138 and non-identifying information indexing system 137 respectively and are stored in source data index 145 as identifying index data 148 or non-identifying index data 147 respectively. Non-identifying Index data 147 and identifying index data 148 may be stored in any competent index form including but not limited to inverted-index, hashing, graph or tree structure, fuzzy matching, Bayesian matching, vector matching, inverted cosine, etc. In some implementations, identifying information indexing system 138 and non-identifying information indexing system 137 use the annotations from grammatical analysis system 134 to create non-identifying index data 147 and/or identifying index data 148 of one or more of the following grammar constraint type in source data index 145:

1. tokenConstraint,

2. phraseConstraint,

3. clauseConstraint,

4. sentenceConstraint,

5. paragraphConstraint,

6. sectionConstraint, and

7. source/typeConstraint,

each (1-7) relating to the indexing of location (begin/end byte offset and document of documents 142) in non-identifying index data 147 and/or identifying index data 148 and, as applicable, being constrained by being indexed in non-identifying index data 147 and/or identifying index data 148 to the grammatical type (e.g. part-of-speech, syntactic category, etc.) of each occurrence in documents 142.

Query Application Algorithms

Within query unit 109, non-identifying query application 110 and identifying query application 111 algorithms include but are not limited to Boolean, Fuzzy Set, Grammar Operator Query Application Algorithm, term order and term proximity operators, term frequency and distribution operators. Query application algorithms are implemented in such a manner that the non-identifying query application 110 can query only non-identifying index data 147. Identifying query application 111 can query non-identifying index data 147, identifying index data 148, documents 142 and annotations 143 performing both indexed retrieval as well as any analysis or retrieval operations on-the-fly at query time. Non-identifying query application 110 and identifying query application 111 can be run under manual end-user control or can perform stored filtering, queries, analysis and retrieval in batches or in real-time providing alerts, routing and/or filtering according to preset criteria. In some implementations, multiple de-centralized instantiations of identity control system 100 operate such each instantiation of non-identifying query application 110 and identifying query application 111 operate in parallel to perform merging and data fusion between all federated sites in a manner that normalizes the analysis, retrieval and filtering results across all federated sites.

Access Unit

FIG. 1D is a detailed drawing of an access unit. Access unit 112 manages identifier index 301 and controls administrative-user and end-user access to non-identifying query application 110 and identifying query application 111. Access unit 112 is composed of authentication control unit 307, identifier manager unit 303 and identifier index 301. Identifier manager unit 303 is communicatively coupled to identifier index 301 by communication link 396 and is communicatively coupled to access control unit 307 by communication link 393.

Identifier manager unit 303 is composed of identifier collection application 321, identifier retrieval application 323 and identifier verification application 327.

Identifier collection application 321 retrieves individual and/or entity identifying information from identifying index data 148. Identifier collection application 321 resolves multiple identifying index data 148 entries to their respective real-world individuals and/or entities. Identifier collection application 321 may use any competent entity resolution system, application or algorithm that is suitable to the identifying index data 148 entry types, including both computer and manual entity resolution techniques or some combination thereof. Resolved identifying index data 148 entries are consolidated under a universal identifier that is unique within all instances of identity control unit 100 and which universal identifier is coupled to identifying index data 148, non-identifying index data 147, documents 142 and annotations 143 only by virtue of co-location and not by virtue of any derivation such as two-way hashing which could potentially be reverse engineered.

Identification retrieval application 323 receives authorized requests from access application 317 and returns identifier index 301 entries that link universal identifier(s) to identifying index data 148, non-identifying index data 147, documents 142 and annotations 143.

Identifier verification application 327 optionally performs the task of verifying that identifying index data 148, non-identifying index data 147, documents 142 and annotations 143 query results that are consolidated under a universal identifier are in fact all appropriately and accurately reference the individual and/or entity represented by that universal identifier. In some implementations, identifier verification application 327 may consist of requests to one or more owners and/or authorized agents (respondents) to respond to one or more questions the answers to which would verify or disprove the relation of the respondents to one or more entries in identifier index 301 without revealing any identifying information to the respondents. In some implementations identifier verification application may comprise the process of presenting one or more owners and/or authorized agents (respondents) with non-identifying abstractions of documents so that the respondents may identify documents that could or could not belong to the respondents, which response may be ranked according to the certainty of the respondent and which may further be analyzed in conjunction with responses to one or more questions also posed to the respondents so as to gain a threshold level of identity verification.

Access control unit 307 is composed of authentication application 311, authorization application 315 and access application 317.

Authentication application 311, the process of verifying the identity of the user, may be performed using any competent authentication measures and processes that are deemed by the information owner(s) and/or agent(s) to be sufficiently secure for the application. These authentication measures and processes may include but are not limited to password, smart card, biometric, single sign-on, multi-layer, Kerberos, SSL, NTLM, PAP, SPAP, CHAP, EAP, RADIUS, and certificate services.

Authorization application 315, the process of determining the roles and permissions a user is entitled to, may be performed using any competent authorization measures and processes that are deemed by the information owner(s) and/or agent(s) to be sufficient for the application. These authorization measures and processes may include but are not limited to LDAP, RADIUS, Auth-proxy, IP Mobile, reverse access, TACACS+, OAuth, and access tokens.

Access application 317 enables the performance of administrative and query tasks by an authenticated user according to the roles and permissions assigned to an authenticated user by authorization application 315.

In some roles, an authenticated user may be granted full and unrestricted access to all aspects of identity control system 100. In some roles, an authenticated user may be granted only restricted access to some or all aspects of identity control system 100.

In some roles, an authenticated user may be granted access to use identifier index 301 entries in identifying query application 111 and/or non-identifying query application 110 to the enablement of queries and return and consolidation of results for specific identified individual(s) and/or entity(ies). In some implementations, access application 317 may, based on the authenticated user roles, as determined by authorization application 315, restrict or allow access only to governing policy, owner and/or authorized agent specified subsets of identifying index data 148, non-identifying index data 147, documents 142 and annotations 143. Such subsets may be specified by any competent means including but not limited to named fields, marked entries and/or failure of some threshold test.

Access application 317 may perform the process of communicating queries and results between administrators or end-users and identifier manager unit 303 or non-identifying query application 110 and identifying query application 111 by any competent data communication methods that provide secure communications that are deemed by the information owner(s) and/or agents(s) and/or governing bodies to be sufficient for the application.

Computer Implementations

In some implementations, the techniques for implementing identity control as described in FIGS. 1A to 2 can be implemented using one or more computer programs comprising computer executable code stored on a computer readable medium and executing on identity control system 100. The computer readable medium may include a hard disk drive, a flash memory device, a random access memory device such as DRAM and SDRAM, removable storage medium such as CD-ROM and DVD-ROM, a tape, a floppy disk, a CompactFlash memory card, a secure digital (SD) memory card, or some other storage device.

In some implementations, the computer executable code may include multiple portions or modules, with each portion designed to perform a specific function described in connection with FIGS. 1A to 2 above. In some implementations, the techniques may be implemented using hardware such as a microprocessor, a microcontroller, an embedded microcontroller with internal memory, or an erasable programmable read only memory (EPROM) encoding computer executable instructions for performing the techniques described in connection with FIGS. 1A to 2. In other implementations, the techniques may be implemented using a combination of software and hardware.

Processors suitable for the execution of a computer program include, by way of example, both general and special purpose microprocessors, and any one or more processors of any kind of digital computer, including graphics processors, such as a GPU. Generally, the processor will receive instructions and data from a read only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. Information carriers suitable for embodying computer program instructions and data include all forms of non-volatile memory, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

A number of embodiments have been described. Nevertheless, it will be understood that various modifications may be made without departing from the spirit and scope of the claims. Accordingly, other embodiments are within the scope of the following claims.

What is claimed is:

1. A method comprising:
performing data abstractions of both individual and/or entity identifying information and non-identifying information in one or more documents;
independently indexing and storing the indexes of both identifying and non-identifying information;
performing query, retrieval and presentation tasks against and on some or all of the non-identifying information in one or more documents;
performing query, retrieval and presentation tasks against and on some or all of the identifying information and non-identifying information in one or more documents;
creating presentations of one or more documents that contain some or all only of non-identifying information;
creating representations of one or more documents that contain some or all of both non-identifying information and identifying information.

2. The method of claim 1 wherein performing data abstraction comprises:
representing non-identifying information using codes;

3. The method of claim 1 wherein performing data abstraction comprises:
representing non-identifying information using codes with values;

4. The method of claim 1 wherein performing data abstraction comprises:
representing non-identifying information using only stop-words and the words that map to non-identifying codes;

5. The method of claim 1 wherein performing data abstraction comprises:
representing identifying information using codes;

6. The method of claim 1 wherein performing data abstraction comprises:
representing identifying information using codes with associated values;

7. The method of claim 1 wherein performing data abstraction comprises:
representing the contextual relations between codes;

8. The method of claim 1 wherein performing data abstraction comprises:
representing the semantic qualifiers of codes as codes;

9. The method of claim 1 wherein performing data abstraction comprises:
representing the semantic qualifiers of codes as codes with values;

10. The method of claim 1 wherein performing data abstraction comprises:
ranking the accuracy of code abstractions;

11. The method of claim 1 wherein performing data abstraction comprises:
ranking the accuracy of contextual relations between codes;

12. The method of claim 1 wherein performing data abstraction comprises:
ranking the accuracy of semantic qualifiers of codes;

13. The method of implementing claim 1 comprising:
Indexing Identifying information and identifying information codes;

14. The method of implementing claim 1 comprising:
Indexing non-Identifying information and non-identifying information codes

15. The method of implementing claim 1 comprising:
storing the Indexes of Identifying information and identifying information codes;

16. The method of implementing claim 1 comprising:
storing the Indexes of non-Identifying information and non-identifying information codes;

17. A method comprising:
manipulating individual and/or entity identifying information by obfuscation of identifying information;
manipulating individual and/or entity identifying information by transforming the individual and/or entity identifying information to a group level;

18. The method of implementing claim 17 comprising:
obfuscating identifying information by means of deletion;

19. The method of implementing claim 17 comprising:
obfuscating identifying information by means of redaction;

20. The method of implementing claim 17 comprising:
transforming identifying information by means of replacing individual or entity identifying information with a group designation;

21. The method of implementing claim 17 comprising:
transforming identifying information by means of replacing individual or entity identifying information with an area designation;

22. A method comprising:
indexing and storing source documents, annotations and the indexes thereof at sites that perform search and retrieval operations;

23. The method of claim 22, wherein indexing comprises:
creating an index of the hierarchy or contextual relations of words, sections, fields and/or contextual components of a document;

24. The method of claim 22, wherein indexing comprises:
creating an index of the words within the scope of individual hierarchy or contextual relations of a document;

25. The method of claim 22, wherein storing comprises:
maintaining secure repositories of source documents, annotations and indexes;

26. The method of claim 22, wherein storing comprises:
maintaining open repositories of source documents, annotations and indexes that contain only non-identifying information;

27. The method of claim 22, wherein a site comprises:
a physical storage location;

28. The method of claim 22, wherein a site comprises:
a virtual storage location;

29. The method of claim 22, wherein a computing site comprises:
a communicating group of physical and/or virtual storage locations;

30. The method of claim 22, wherein a computing site comprises:
a group of physical and/or virtual storage locations linked with access controlled communications;

31. A method comprising:
providing access control to source documents, annotations and indexes that physically and logically remain under the authentication, authorization and verification powers of the identifying information owners;

32. A method of claim 31 comprising:
authenticating user identity prior to granting system access.

33. A method of claim 31 comprising:
authorizing users actions according to assigned roles.

34. A method of claim 31 comprising:
Verifying the identities of individuals and/or entities referenced in documents to which users are granted access.

35. A method of claim 31 wherein verifying the identities of individuals and/or entities referenced in documents further comprises:
verifying the identities of individuals and/or entities referenced in documents to which users are granted access by means of requesting responses to questions that will identify the individuals and/or entities without revealing the identities of any individuals and/or entities that may be incorrectly collated (responses to questions).

36. A method of claim 31 wherein verifying the identities of individuals and/or entities referenced in documents further comprises:
verifying the identities of individuals and/or entities referenced in documents to which users are granted access by means of requesting from one or more owners and/or authorized agents a ranked score of whether one or more non-identifying abstract document belongs to said owner(s) (verification ranking).

37. A method of claim 31 wherein verifying the identities of individuals and/or entities referenced in documents further comprises:
verifying the identities of individuals and/or entities referenced in documents by means of a combined analysis of responses to questions and verification rankings.

38. A computer program product, encoded on a computer-readable medium, operable to cause data processing apparatus to perform operations comprising:
the operations of each of the methods of claims 1-37.
